(19) United States
(12) Patent Application Publication
(10) Pub. No.: US 2015/0365750 A1
(43) Pub. Date: Dec. 17, 2015

(54) Activating Method and Electronic Device Using the Same

(71) Applicant: MEDIATEK INC., Hsin-Chu (TW)

(72) Inventors: Liang-Che Sun, Taipei (TW); Yiou-Wen Cheng, Hsinchu City (TW)

(21) Appl. No.: 14/305,007

(22) Filed: Jun. 16, 2014

(51) Int. Cl. H04R 1/08; H04R 3/04

(52) U.S. Cl. CPC H04R 1/08; H04R 3/04

(57) ABSTRACT

An electronic device includes a receiver and an activator. The receiver includes a microphone; and a signal detector, coupled to the microphone, for determining whether a valid input signal received from the microphone is a voice signal or an ultrasonic signal by comparing a frequency of the valid input signal with at least two frequency bands, and accordingly passing the valid input signal. The activator includes a voice detection module, for performing a voice activated process; and an ultrasonic detection module, for performing an ultrasound activated process. The voice detection module and the ultrasonic detection module are enabled by the signal detector simultaneously or separately.

### BACKGROUND

The present invention relates to an activating method and an electronic device using the same, and more particularly, to an activating method capable of activating an electronic device via voice and/or ultrasound and the electronic device using the same.

With advancements of technology, mobile devices are widely used in our daily life. Most mobile devices have embedded a microphone capable of an always listening function. A voice wake-up function may be implemented with the microphone, where a keyword may be predefined for the mobile device. If a user speaks the keyword, which is detected by the mobile device, the mobile device may be waked up or activated for performing predefined functions. With the voice wake-up function, the user may instruct the mobile device to perform any function without manually touching any button.

Ultrasound has been applied in biology, medicine, diagnostic usage and military affairs. In the electronic industry, ultrasound is also applied for signal transmissions. For example, a remote control may use ultrasonic signals for controlling consumer electronics or household products such as televisions, refrigerators and air conditioners. The ultrasonic transmitter may be integrated with wearable devices, so that a watch or glasses may transmit ultrasonic signals for remote controlling an electronic device to turn on.

However, the conventional microphone is only able to receive human voice in the audible frequency range. Since the conventional microphone equipped in the electronic devices cannot receive ultrasonic signals, those devices are limited to voice-controlled operations.

### SUMMARY

It is therefore an objective of the present invention to provide a method of activating an electronic device via voice and/or ultrasound, wherein the electronic device comprises a single detector capable of detecting voice signals and ultrasonic signals simultaneously.

The present invention discloses an electronic device. The electronic device comprises a receiver and an activator. The receiver comprises a microphone; and a signal detector, coupled to the microphone, for determining whether a valid input signal received from the microphone is a voice signal or an ultrasonic signal by comparing a frequency of the valid input signal with at least two frequency bands, and accordingly passing the valid input signal. The activator, coupled to the receiver, comprises a voice detection module, for performing a voice activated process; and an ultrasonic detection module, for performing an ultrasound activated process, wherein the voice detection module and the ultrasonic detection module are enabled by the signal detector simultaneously or separately.

The present invention further discloses a method of activating an electronic device having a voice detection module and an ultrasonic detection module. The method comprises determining, by a signal detector, whether a valid input signal received from a microphone is a voice signal or an ultrasonic signal by comparing a frequency of the valid input signal with at least two frequency bands; and enabling, by the signal detector, the voice detection module and the ultrasonic detection module according to the valid input signal to simultaneously or separately perform a voice activated process and an ultrasound activated process.

The present invention further discloses a non-transitory computer-readable medium storing program instructions for controlling a signal detector to activate an electronic device. The program instructions comprise determining whether a valid input signal received from a microphone is a voice signal or an ultrasonic signal by comparing a frequency of the valid input signal with at least two frequency bands and accordingly passing the valid input signal; and enabling a voice activated process and an ultrasound activated process simultaneously or separately according to the received valid input signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a schematic diagram of voice recognition according to an embodiment of the present invention.

FIG. 3 is a schematic diagram of a detailed illustration of the voice detection module.

FIG. 4 is a schematic diagram of the electronic device performing voice activation with an adaptable threshold value.

FIG. 5 is a schematic diagram of the ultrasonic detection module pairing with an ultrasonic transmitter.

FIG. 6 is a schematic diagram of the electronic device performing ultrasonic activation.

FIG. 7 is a schematic diagram of an activation process according to an embodiment of the present invention.

### DETAILED DESCRIPTION

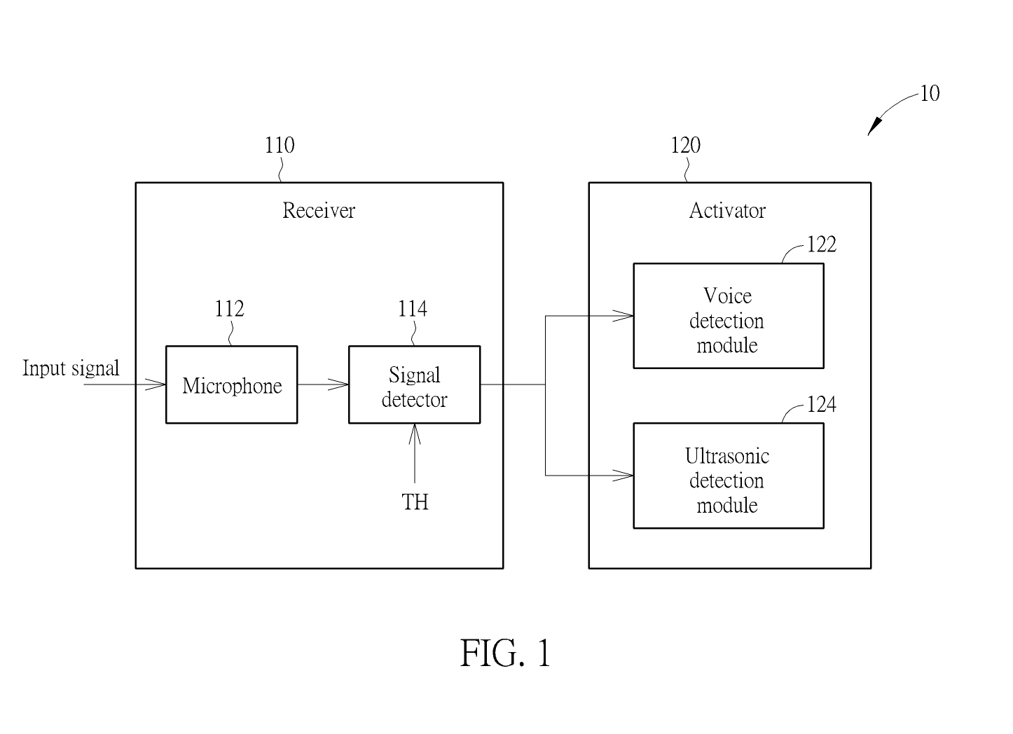

Please refer to FIG. 1, which is a schematic diagram of an electronic device 10 according to an embodiment of the present invention. As shown in FIG. 1, the electronic device 10 may be a smart phone, portable media player, desktop, laptop, tablet or personal digital assistant (PDA), etc. In addition, the electronic device 10 may also be a household product that can be remotely controlled such as a smart television, refrigerator or air conditioner. For the sake of simplicity, only the devices utilized for realizing the activating method of the present invention are illustrated in FIG. 1. These devices include a receiver 110 and an activator 120. Other components or modules such as a display screen, camera or input device may be disposed arbitrarily according to system requirements, and are omitted in FIG. 1 since these components do not affect the illustration of the present embodiment.

In detail, the receiver 110 includes a microphone 112, and a signal detector 114. The microphone 112 is utilized for receiving an input signal. Please note that the input signal may be in a voice frequency band (i.e. between 20 Hz and 20 kHz) or in an ultrasonic frequency band (i.e. greater than 20 kHz). Distinct from the conventional microphone that can only receive audio signals within the voice frequency band, the microphone 112 monitors the full frequency band. For example, the microphone 112 is able to receive both the input signal within the voice frequency band and the input signal within the ultrasonic frequency band. The signal detector 114, coupled to the microphone 112, is utilized for determining whether a valid input signal received from the microphone 112 is a voice signal or an ultrasonic signal by comparing a frequency of the valid input signal with at least two frequency bands, and then accordingly passing the valid input signal to one of a voice detection module 122 and an ultrasonic detection module 124 within the activator 120, wherein the at least two frequency bands may include a voice frequency band, an ultrasonic frequency band and other frequency bands.

In one embodiment, the signal detector 114 further determines whether an input signal received from the microphone 112 is a valid input signal by comparing at least one threshold value with at least one statistical parameter of the input signal, wherein the at least one statistical parameter is from time domain and/or spectrogram. For example, the strength of the input signal may be considered as a statistical parameter. If the signal strength is greater than a corresponding threshold TH, the input signal will be determined as a valid input signal. In another example, the frequency offset of the input signal may be considered as a statistical parameter. If the frequency offset does not exceed a corresponding threshold TH, the input signal will be determined as a valid input signal.

After the input signal is determined to be valid, the signal detector 114 then determines the category of the valid input signal. For example, the signal detector 114 determines that the valid input signal is a voice signal or an ultrasonic signal according to the frequency of the valid input signal. If the frequency of the valid input signal is within the voice frequency band, the valid input signal will be determined to be a voice signal; while if the frequency of the valid input signal is within the ultrasonic frequency band, the valid input signal will be determined to be an ultrasonic signal. It should be noted that only the input signal determined to be valid by the signal detector 114 will be sent to the activator 120.

In general, the microphone 112 may simultaneously monitor the voice frequency band and the ultrasonic frequency band. The same threshold value or different threshold values are predefined for the voice signals and the ultrasonic signals. The threshold value TH may be determined to be a fixed signal strength or energy if the at least one statistical parameter includes the signal strength. In an embodiment, the threshold value TH may be defined in accordance with a specific signal-to-noise ratio (SNR). In such a condition, the threshold value TH in signal strength may fluctuate according to environmental noises. For example, in a noisy environment, the threshold value TH may be increased to a higher energy level. The threshold value TH may be determined for a specific frequency band or all voice/ultrasonic frequency band; in order words, the threshold value TH may be interpreted in the frequency domain. For example, if there is only one type of ultrasonic signal in a single frequency assigned for ultrasonic activation, the threshold value TH may only be determined for the specific frequency, and the signal detector 114 may only monitor frequencies near the specific frequency in the ultrasonic frequency band.

Please note that, since the microphone 112 is always monitoring surrounding sounds and ultrasounds and the signal detector 114 should be always active for filtering out unwanted sounds and ultrasounds, it is desirable to reduce power consumption in the microphone 112 and the signal detector 114, while the activator 120 is responsible for complex verification and activation processes and thus requires more power consumption. If the threshold value TH is adaptive to environmental noises, there may be fewer unwanted noise signals passing through the signal detector 114 and entering the activator 120, which reduces unnecessary power consumption.

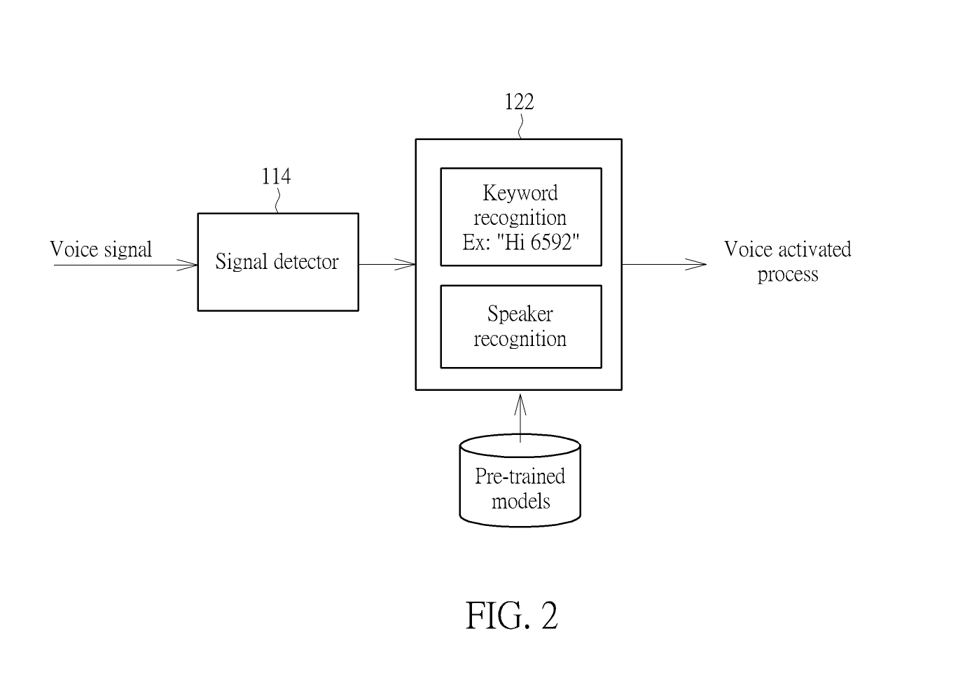

The activator 120, coupled to the receiver 110, includes a voice detection module 122 and an ultrasonic detection module 124. When the valid input signal is determined to be a voice signal by the signal detector 114, the valid input signal may be sent to the voice detection module 122 and the voice detection module 122 may start to perform voice activation. In the voice activation, voice recognition may be performed first. Please refer to FIG. 2, which is a schematic diagram of voice recognition according to an embodiment of the present invention. As shown in FIG. 2, after a valid input signal determined to be a voice signal passes through the signal detector 114 and enters the voice detection module 122, the voice detection module 122 starts to perform voice recognition. The voice recognition may include keyword recognition and speaker recognition. Before the voice recognition is performed, a password model should be pre-trained for executing the recognition. For example, for the keyword recognition, the user may say a pass phrase (e.g. “Hi 6592”) several times, and the voice detection module 122 may learn the pass phrase “Hi 6592” via a voice model such as Gaussian mixture model (GMM) or hidden Markov model (HMM). After the password model is built in, people can speak this pass phrase to activate the voice activated process. For example, people may turn on the electronic device 10 by speaking “Hi 6592” to the electronic device 10.

In an embodiment, the speaker recognition may be incorporated with the voice recognition. In addition to the modeling of pass phrase, the pre-trained voice model may further include modeling of voice characteristics of a user when the user says the pass phrase “Hi 6592” for pre-training. In such a condition, the voice activated process will be activated only when the user speaks “Hi 6592” to the electronic device 10. When any other user speaks the pass phrase “Hi 6592”, this voice activated process may not be activated, which improves the security. Please note that, the speaker recognition may also be applied alone, where the user has to say more words or phrases for pre-training. A voice model with the voice characteristics of the user can therefore be generated.

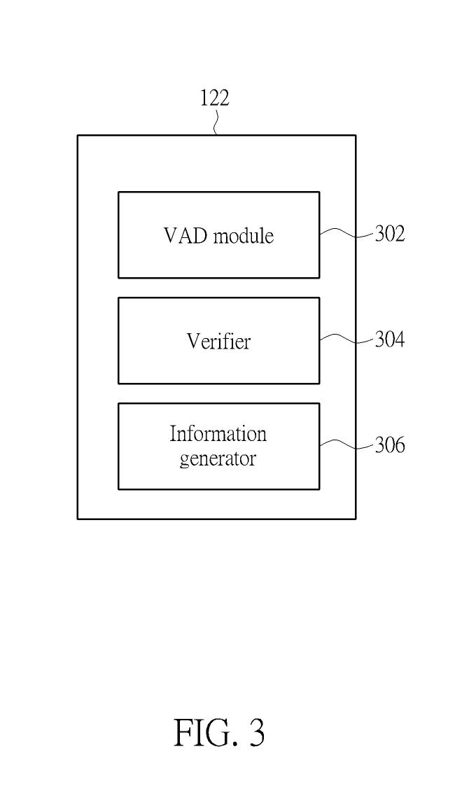

Please refer to FIG. 3, which is a schematic diagram of a detailed illustration of the voice detection module 122. As shown in FIG. 3, the voice detection module 122 includes a voice activity detection (VAD) module 302, a verifier 304 and an information generator 306. The VAD module 302 is utilized for retrieving the valid input single determined to be the voice signal. For example, the voice signal may be accompanied by echoes or noises, and the VAD module 302 is capable of eliminating these echoes or noises, in order to retrieve the accurate voice signal. The verifier 304 may build a voice model by training a pass phrase several times in advance and compare the voice model with the received voice signal, in order to determine whether to perform the voice activated process. The information generator 306 is utilized for generating signal information according to the voice signal, in order to adjust the corresponding threshold value TH stored in the signal detector 114. For example, in a noisy environment, there may be more unwanted voice signals having larger strength and thereby passing through the signal detector 114 to the voice detection module 122. When the number of unwanted voice signals detected by the voice detection module 122 within a specific period exceeds a predetermined number, the information generator 306 may notify the signal detector 114 to increase the threshold value TH corresponding to the signal strength, in order to prevent unwanted voice signals from being received. Please note that the structure of the voice detection module 122 shown in FIG. 3 is only one of various embodiments of the voice detection module 122. In other embodiments, the voice detection module 122 may also be implemented by other methods, which should not be limited herein.

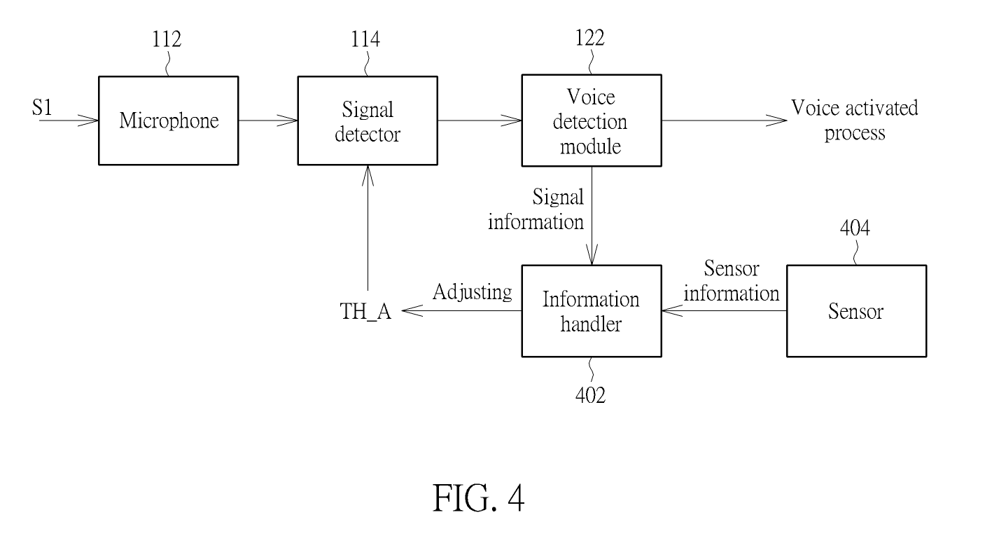

Please refer to FIG. 4, which is a schematic diagram of the electronic device 10 performing voice activation with an adaptable threshold value TH_A. As shown in FIG. 4, the microphone 112 first receives an input signal S1. If the input signal S1 is determined to be a valid voice signal, the voice signal S1 may pass through the signal detector 114 and enter the voice detection module 122. The voice detection module 122 then compares the voice signal S1 with a built-in voice model and determines whether the voice signal S1 is able to activate the voice activated process. The electronic device 10 further includes an information handler 402 and a sensor 404. The information handler 402 is utilized for controlling the magnitude of the threshold value TH_A. The information handler 402 may receive sensor information generated by the sensor 404 and signal information generated by the information generator in the voice detection module 122, and adjust the threshold value TH_A according to the sensor information and the signal information. The sensor 404 may be in any type for generating any type of sensor information. For example, when a user is driving a car, the environmental noise may be larger when the car speed is higher. In this embodiment, the sensor 404 may be a speed sensor which provides speed information for the information handler 402. The information handler 402 then increases the threshold value TH_A with a higher car speed or decreases the threshold value TH_A with a lower car speed. In an embodiment, the information handler 402 may incorporate the speed information with the signal information or other sensor information to adjust the threshold value TH_A. Please note that the number and type of the sensor 404 and the sensor information should not be limited herein. Besides, the information handler 402 is able to adjust one or more threshold values stored in the signal detector 114.

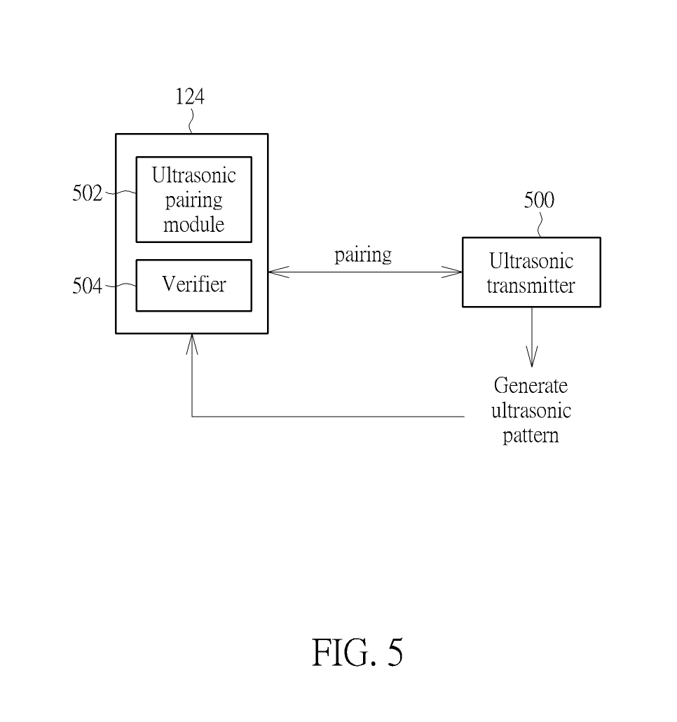

When the valid input signal is determined to be an ultrasonic signal by the signal detector 114, the ultrasonic signal may be sent to the ultrasonic detection module 124 and the ultrasonic detection module 124 may start to perform ultrasonic activation. Before performing the ultrasonic activation, the ultrasonic detection module 124 of the electronic device 10 may obtain a predetermined ultrasonic pattern either from a specific ultrasonic transmitter or a server via a registering process. In an embodiment, the ultrasonic detection module 124 may be registered in the server, in order to download the ultrasonic pattern from the server. In another embodiment, the ultrasonic detection module 124 is registered by pairing with an ultrasonic transmitter and then obtains the ultrasonic pattern from the ultrasonic transmitter. Please refer to FIG. 5, which is a schematic diagram of the ultrasonic detection module 124 pairing with an ultrasonic transmitter 500. As shown in FIG. 5, the ultrasonic detection module 124 includes an ultrasonic pairing module 502 and a verifier 504. The ultrasonic pairing module 502 is utilized for exchanging pairing information with the ultrasonic transmitter 500. The pairing information is, for example, the device ID. The verifier 504 is utilized for retrieving the valid input signal determined to be the ultrasonic signal from the signal detector 114, and comparing the ultrasonic signal with at least one predetermined ultrasonic pattern to determine whether to perform the ultrasound activated process. In the pairing process, the ultrasonic transmitter 500 may generate an ultrasonic pattern in a specific ultrasonic frequency and transmit the ultrasonic pattern to the electronic device 10. The ultrasonic detection module 124 of the electronic device 10 receives the ultrasonic pattern and saves the ultrasonic pattern in a memory or database. If the activation can only be triggered by this ultrasonic pattern, the signal detector 114 only needs to check the specific ultrasonic frequency and frequencies near the specific ultrasonic frequency.

In an embodiment, the ultrasonic detection module 124 also includes an information generator (not illustrated), for generating signal information according to the ultrasonic signal received after the registering process is complete, so as to adjust the threshold value stored in the signal detector 114. In other words, the threshold value for ultrasonic signal detection may also be adjusted. For example, if there are a lot of unwanted ultrasonic signals passing through the signal detector 114 but cannot be paired with the predetermined ultrasonic pattern, these ultrasonic signals may be sent by other ultrasonic transmitters which are not paired with the ultrasonic pairing module 502 of the ultrasonic detection module 124. In such a condition, the threshold value for ultrasonic signal detection may be increased, in order to filter out more unwanted ultrasonic signals in the signal detector 114, so that power consumption of the ultrasonic detection module 124 may be saved. Please note that the threshold value may be corresponding to signal magnitude, frequency offset or SNR; this should not be limited herein.

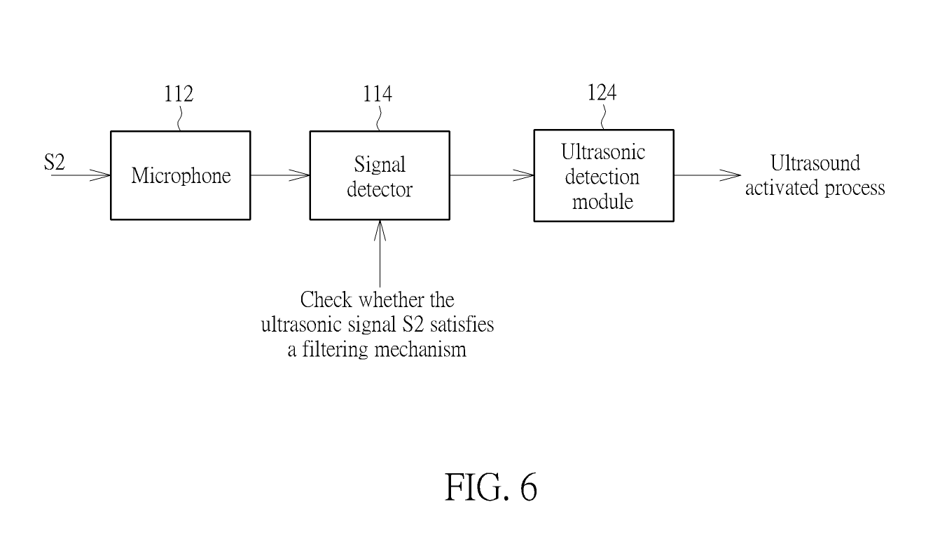

Please refer to FIG. 6, which is a schematic diagram of the electronic device 10 performing ultrasonic activation. As shown in FIG. 6, the microphone 112 first receives an input signal S2 from the ultrasonic transmitter 500. If the input signal S2 is a valid input signal and determined to be an ultrasonic signal by the signal detector 114, the ultrasonic signal S2 may pass through the signal detector 114 and enter the ultrasonic detection module 124. The ultrasonic detection module 124 then performs ultrasonic activation. The verifier 504 of the ultrasonic detection module 124 may compare the ultrasonic signal S2 with the pre-received ultrasonic pattern and determine whether the ultrasonic signal S2 meets the pre-received ultrasonic pattern. If the ultrasonic pattern is met, the ultrasonic signal S2 is able to activate the ultrasound activated process.

Please note that the signal detector 114 passes or blocks the input signal S2 (i.e. determines whether the input signal S2 is valid) by checking whether the ultrasonic signal S2 satisfies a filtering mechanism. Such a filtering mechanism may include filtering of frequency offset, signal energy or SNR. For example, for an energy-based filtering, the signal detector 114 may pass the input signal S2 if the energy of the input signal S2 is greater than a predetermined threshold; for an SNR filtering, the signal detector 114 may pass the input signal S2 if the SNR of the input signal S2 is greater than a predetermined threshold. In consideration of frequency offset, the signal detector 114 may not only check the ultrasonic frequency in which a specific ultrasonic pattern for triggering the activation is located, but also check frequencies near the specific ultrasonic frequency due to the Doppler effect. According to the Doppler effect, if the ultrasonic transmitter 500 is approaching the electronic device 10, the frequency of the ultrasonic signal received by the electronic device 10 may be slightly higher than the original frequency of this ultrasonic signal; if the ultrasonic transmitter 500 is leaving the electronic device 10, the frequency of the ultrasonic signal received by the electronic device 10 may be slightly lower than the original frequency of this ultrasonic signal. As a result, the signal detector 114 should detect the frequencies near the specific ultrasonic frequency. If a user approaches the electronic device 10 while using the ultrasonic transmitter 500 to send a signal, this signal can therefore be detected. In general, since ultrasonic signals can only be transmitted within a short distance (e.g. 2 to 3 meters), the user may usually hold or wear the ultrasonic transmitter 500 and come near the target to send the ultrasonic signal; hence, the consideration of the Doppler effect should not be ignored.

As mentioned above, in order to save power consumption, the threshold value of the signal detector 114 may be adaptive to environments. On the other hand, the power consumption may also be reduced in the ultrasonic transmitter 500. In an embodiment, the ultrasonic transmitter 500 may be implemented with a motion detector. Since ultrasonic signals can only be transmitted within a short distance, before the ultrasonic transmitter 500 transmits a signal, the user always moves the ultrasonic transmitter 500 near the target of the signal. The motion detector is utilized for detecting the motion of the ultrasonic transmitter 500. In order to save power consumption, the ultrasonic transmitter 500 may send ultrasonic signals only when it is moving instead of continuously sending ultrasonic signals. No ultrasonic signal is transmitted when the ultrasonic transmitter 500 is static, which significantly reduces power consumption of the ultrasonic transmitter 500. Please note that motion detection may be performed according to the characteristics of the ultrasonic pattern. In other words, for different ultrasonic patterns (e.g. having different frequencies, energies or SNR), the motion detector may apply different criteria to determine the motion of the ultrasonic transmitter 500, so as to determine whether to send the ultrasonic signals.

In an embodiment, the ultrasonic activation may be incorporated with voice verification in order to enhance security. For example, after the ultrasonic detection module 124 determines that a received ultrasonic signal meets a predefined ultrasonic pattern, the ultrasonic detection module 124 may ask the user for further speaking a pass phrase. The ultrasound activated process may be activated only when an accurate pass phrase is received. Please note that the voice verification for ultrasonic activation may include keyword recognition and/or speaker recognition. In other words, the voice verification can be performed via the verification of the pass phrase, the verification of a user's voice characteristics or a combination of both. The voice verification is, for example, performed by the voice detection module 122, and the verification result will be sent to the ultrasonic detection module 124 for determining whether or not to activate the ultrasound activated process. In another embodiment, when the ultrasonic transmitter sends an ultrasonic signal, the user is required to say the pass phrase simultaneously. The ultrasound activated process is activated only when the ultrasonic signal and the pass phrase are both received by the activator 120. To be specific, the microphone 112 may receive two or more input signals of different types at one time, and the signal detector 114 may determine whether to filter out each input signal based on at least one threshold value corresponding to the type of each input signal. If the received voice pass phrase and the ultrasonic signal are both determined to be valid, the signal detector 114 respectively passes the voice pass phrase and the ultrasonic signal to the voice detection module 122 and the ultrasonic detection module 124 for further verification. That is, the voice detection module 122 and the ultrasonic detection module 124 are enabled by the signal detector 114 simultaneously.

Please note that, the present invention is capable of simultaneously monitoring the voice frequency band and the ultrasonic frequency band by a single receiver 110, so as to activate the voice activated process via the voice signal and the ultrasound activated process via the ultrasonic signal simultaneously or separately. That is, the receiver 110 is shared by the voice detection module 122 and the ultrasonic detection module 124.

The details of the voice/ultrasound activated process will be illustrated as follows. For example, by performing the voice/ultrasound activated process, the electronic device 10 may be turned on and/or an application in the electronic device 10 may be launched. The application may be a voice assistant application, an application predetermined by the user, or a commonly used application. In another embodiment, the voice/ultrasound activated process being performed may adjust an environment setting of the electronic device 10, or enable data synchronization or file transmission between the electronic device 10 and other electronic devices. For example, a user owning several consumer electronic products may always need to synchronize data between these electronic products such as a laptop, tablet, camera, smart phone and television. The voice activated process and/or the ultrasound activated process can thereby be considered as activating the data synchronization. For example, the user has used a camera to take many pictures and the corresponding picture files are stored in the camera. If the user needs to transmit the picture files to his/her laptop, the user may speak a keyword to trigger the voice activated process and/or send an ultrasonic signal to trigger the ultrasound activated process, in order to activate file transmission.

More specifically, when the voice activated process is applied for data transmission (or synchronization), the user may speak a predetermined keyword to the camera to initiate a wireless transmission between the camera and the laptop, so that the camera may transmit the data/files to the laptop. The wireless transmission may be Bluetooth, wireless fidelity (Wi-Fi) or ultrasonic transmission, etc. In such a condition, the camera may be considered as the electronic device 10. When the ultrasound activated process is applied for data transmission (or synchronization), the user may operate the laptop to transmit an ultrasonic signal having a predetermined ultrasonic pattern to the camera. After receiving the ultrasonic signal and determining the ultrasonic signal to be valid, the camera may start to transmit the data/files to the laptop. In such a condition, the camera may be considered as the electronic device 10 and the laptop may be considered as the ultrasonic transmitter 500. In another embodiment, the user may operate the camera to transmit an ultrasonic signal having a predetermined ultrasonic pattern to the laptop. After receiving the ultrasonic signal and determining the ultrasonic signal to be valid, the laptop may start to receive the data/files from the camera. In such a condition, the laptop may be considered as the electronic device 10 and the camera may be considered as the ultrasonic transmitter 500. In another embodiment, the electronic device 10 may be electrically connected to or communicate with an external device, so that the voice/ultrasonic activation implemented by the electronic device 10 are able to launch an application in the external device. For example, a remote controller may be equipped in a mobile phone for triggering an ultrasound activated process such as data transmission (or synchronization) between the camera and the laptop. The user may operate the mobile phone to transmit an ultrasonic signal having a predetermined ultrasonic pattern to the camera. After the camera receives the ultrasonic signal and determines the ultrasonic signal to be valid, the camera may start to transmit data/files to the laptop. Please note that although the ultrasound activated process is triggered by the ultrasonic signal, the data transmission performed in the ultrasound activated process may not be limited to ultrasonic transmission. This data transmission may also be realized by other transmission techniques such as Bluetooth or Wi-Fi.

In an embodiment, an application of advertising may be performed by ultrasonic activation. In a department store or a shopping mall, store owners may want to broadcast advertisements to shoppers. A store may use an ultrasonic transmitter to continuously deliver ultrasonic signals with a tag, which is predetermined to be corresponding to an advertisement of the store and is able to be identified by any electronic device embedded with the abovementioned ultrasonic activation function. When a user carrying a mobile phone embedded with the ultrasonic activation function passes through the store, the signal detector in the mobile phone may detect the ultrasonic signal, and the ultrasonic detection module further verifies that the received ultrasonic signal has the tag. In such a condition, the ultrasonic transmitter may start to deliver the advertisement to the mobile phone (e.g. via a text message), which significantly facilitates the advertising. Please note that this embodiment may also be implemented by voice activation, while the store may continuously deliver voice signals or music carrying a tag with them. The voice activation module then verifies the voice signal to activate the advertisement transmission.

Since the advertising application is activated only when the user is close to the store, this activation technique may also be applied to find the position of a user. In an embodiment, the voice/ultrasonic activating method may be utilized for indoor positioning. For example, in a department store or a shopping mall, ultrasonic transmitters may be disposed in any indoor places such as counters, restaurants, restrooms and stairwells. Each ultrasonic transmitter may be assigned a distinct tag or ultrasonic pattern corresponding to its location. When a user carrying a mobile phone embedded with the ultrasonic activation function passes through an ultrasonic transmitter, the ultrasonic signal with a corresponding tag may be received by the mobile phone. The position of the user can therefore be obtained according to the tag.

Please note that in the above embodiments of advertising and indoor positioning, the ultrasonic transmitter may not be paired with a specific mobile phone when the advertisement needs to be sent to multiple users. In such a condition, predetermined ultrasonic patterns may be transmitted to the ultrasonic transmitters and the electronic devices from a host or a cloud server, where each ultrasonic transmitter may correspond to a specific ultrasonic pattern and the electronic devices should be able to recognize more than one ultrasonic pattern. In another embodiment, as long as an ultrasonic pattern transmitted by the ultrasonic transmitter is able to be verified by the electronic devices, this ultrasonic pattern may be obtained or acknowledged by the electronic devices by any method, which should not be limited herein.

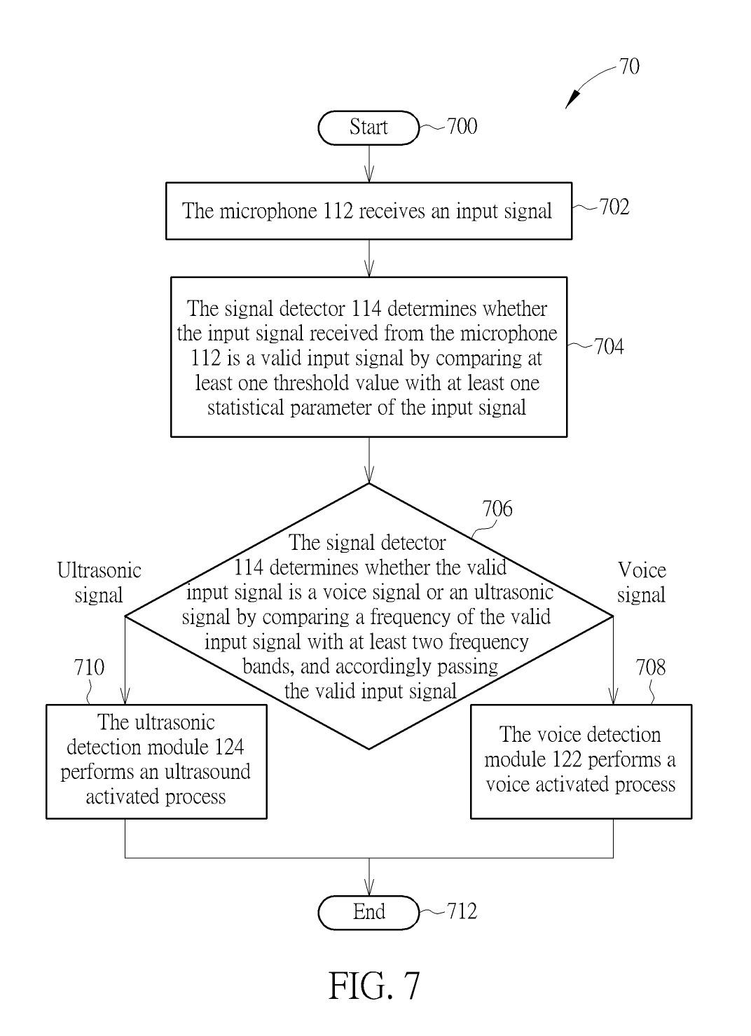

The abovementioned method of activating an electronic device can be summarized into an activation process 70, as shown in FIG. 7. The activation process 70 includes the following steps:

Step 700: Start.

Step 702: The microphone 112 receives an input signal.

Step 704: The signal detector 114 determines whether the input signal received from the microphone 112 is a valid input signal by comparing at least one threshold value with at least one statistical parameter of the input signal.

Step 706: The signal detector 114 determines whether the valid input signal is a voice signal or an ultrasonic signal by comparing a frequency of the valid input signal with at least two frequency bands, and accordingly passing the valid input signal. If the valid input signal is determined to be a voice signal, go to Step 708; if the valid input signal is determined to be an ultrasonic signal, go to Step 710.

Step 708: The voice detection module 122 performs a voice activated process.

Step 710: The ultrasonic detection module 124 performs an ultrasound activated process.

Step 712: End.

The detailed operations and alternations of the activation process 70 are illustrated in the above description, and will not be narrated herein.

Please note that in the context of this disclosure, a non-transitory computer-readable medium stores programs for use by or in connection with an instruction execution system, apparatus, or device. In this regard, one example, among others, is a non-transitory computer-readable medium embodying a program executable in an electronic device such as the electronic device 10 shown in FIG. 1. In accordance with such examples, the program comprises code for determining whether a valid input signal received from a microphone is a voice signal or an ultrasonic signal by comparing a frequency of the valid input signal with at least two frequency bands and accordingly passing the valid input signal, and code for enabling a voice activated process and an ultrasound activated process simultaneously or separately according to the received valid input signal. Other alternations related to the abovementioned methods may also be compiled to the program executable in the electronic device 10.

The abovementioned computer-readable medium can be any medium that can contain, store, or maintain the program described herein for use by or in connection with the instruction execution system. The computer-readable medium may comprise any one of physical media such as, for example, magnetic, optical, or semiconductor media. More specific examples of a suitable computer-readable medium may include, but not limited to, a magnetic tape, a magnetic floppy diskette, a magnetic hard drive, a memory card, a solid-state drive, a USB flash drive, an optical disc, a random access memory (RAM) including a static random access memory (SRAM), a dynamic random access memory (DRAM) and a magnetic random access memory (MRAM), a read-only memory (ROM) including a programmable read-only memory (PROM), an erasable programmable read-only memory (EPROM), an electrically erasable programmable read-only memory (EEPROM), or other type of memory device.

In the prior art, the conventional receiver equipped in the electronic devices having the voice wake-up function cannot receive or determine ultrasonic signals. Those devices are limited to voice-controlled operations, and even if they receive a signal which is not determined to be a voice signal, this signal cannot further be determined to be another type of signal. In comparison, the present invention is capable of simultaneously monitoring the voice frequency band and the ultrasonic frequency band, and performing the voice activated process or the ultrasound activated process according to the frequency of the received input signal, which reduces the cost of the signal detector and enhances the convenience of voice/ultrasonic activation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a receiver, comprising:
a microphone; and
a signal detector, coupled to the microphone, for determining whether a valid input signal received from the microphone is a voice signal or an ultrasonic signal by comparing a frequency of the valid input signal with at least two frequency bands, and accordingly passing the valid input signal; and
an activator, coupled to the receiver, comprising:
a voice detection module, for performing a voice activated process; and
an ultrasonic detection module, for performing an ultrasound activated process,
wherein the voice detection module and the ultrasonic detection module are enabled by the signal detector simultaneously or separately.

2. The electronic device of claim 1, wherein the at least two frequency bands comprise a voice frequency band and an ultrasonic frequency band, and the microphone simultaneously monitors the voice frequency band and the ultrasonic frequency band.

3. The electronic device of claim 2, wherein the signal detector determines the valid input signal to be the voice signal when the frequency of the valid input signal is in the voice frequency band, or determines the valid input signal to be the ultrasonic signal when the frequency of the valid input signal is in the ultrasonic frequency band.

4. The electronic device of claim 1, wherein the signal detector determines whether an input signal received from the microphone is the valid input signal by comparing at least one threshold value with at least one statistical parameter of the input signal.

5. The electronic device of claim 4, wherein the voice detection module comprises:
a voice activity detection module, for retrieving the valid input signal determined to be the voice signal from the signal detector;
a verifier, for building a voice model in advance and comparing the voice model with the valid input signal determined to be the voice signal to determine whether to perform the voice activated process; and
an information generator, for generating signal information according to the valid input signal determined to be the voice signal, in order to adjust the threshold value stored in the signal detector.

6. The electronic device of claim 5, wherein the electronic device further comprises:
an information handler, for receiving sensor information and/or the signal information of the information generator to adjust the threshold value stored in the signal detector.

7. The electronic device of claim 4, wherein the ultrasonic detection module comprises:
an ultrasonic pairing module, for exchanging pairing information with an ultrasonic transmitter, wherein the valid input signal determined to be the ultrasonic signal by the signal detector is sent from the ultrasonic transmitter; and
a verifier, for retrieving the valid input signal determined to be the ultrasonic signal from the signal detector, and comparing the valid input signal determined to be the ultrasonic signal with at least one predetermined ultrasonic pattern to determine whether to perform the ultrasound activated process.

8. The electronic device of claim 7, wherein the ultrasonic detection module further comprises:
an information generator, for generating signal information according to the valid input signal determined to be the ultrasonic signal, in order to adjust the threshold value stored in the signal detector.

9. The electronic device of claim 7, wherein the activator further performs a voice verification when the ultrasonic detection module receives the ultrasonic signal from the ultrasonic transmitter, in order to determine whether to perform the ultrasound activated process.

10. The electronic device of claim 1, wherein each of the voice activated process and the ultrasound activated process comprises one or a combination of turning on the electronic device, launching a specific application, adjusting an environment setting of the electronic device, receiving files from another electronic device, synchronizing data with another electronic device and performing indoor positioning.

11. A method of activating an electronic device having a voice detection module and an ultrasonic detection module, comprising:
determining, by a signal detector, whether a valid input signal received from a microphone is a voice signal or an ultrasonic signal by comparing a frequency of the valid input signal with at least two frequency bands; and
enabling, by the signal detector, the voice detection module and the ultrasonic detection module according to the valid input signal to simultaneously or separately perform a voice activated process and an ultrasound activated process.

12. The method of claim 11, wherein the at least two frequency bands comprise a voice frequency band and an ultrasonic frequency band, and the microphone simultaneously monitors the voice frequency band and the ultrasonic frequency band.

13. The method of claim 12, wherein the step of determining whether the valid input signal received from the microphone is the voice signal or the ultrasonic signal by comparing the frequency of the valid input signal with the at least two frequency bands and accordingly passing the valid input signal comprises:
determining the valid input signal to be the voice signal when the frequency of the valid input signal is in the voice frequency band; and
determining the valid input signal to be the ultrasonic signal when the frequency of the valid input signal is in the ultrasonic frequency band.

14. The method of claim 11, further comprising:
determining whether an input signal received from the microphone is the valid input signal by comparing at least one threshold value with at least one statistical parameter of the input signal.

15. The method of claim 14, further comprising:
exchanging pairing information with an ultrasonic transmitter, wherein the valid input signal determined to be the ultrasonic signal is sent from the ultrasonic transmitter; and
retrieving the valid input signal determined to be the ultrasonic signal and comparing the valid input signal determined to be the ultrasonic signal with at least one predetermined ultrasonic pattern to determine whether to perform the ultrasound activated process.

16. The method of claim 15, further comprising:
generating signal information according to the valid input signal determined to be the ultrasonic signal, in order to adjust the threshold value.

17. The method of claim 15, further comprising:
performing a voice verification when the ultrasonic signal is received from the ultrasonic transmitter, in order to determine whether to perform the ultrasound activated process.

18. The method of claim 11, wherein each of the voice activated process and the ultrasound activated process comprises one or a combination of turning on the electronic device, launching a specific application, adjusting an environment setting of the electronic device, receiving files from another electronic device, synchronizing data with another electronic device and performing indoor positioning.

19. A non-transitory computer-readable medium storing program instructions for controlling a signal detector to activate an electronic device, the program instructions comprising:
determining whether a valid input signal received from a microphone is a voice signal or an ultrasonic signal by comparing a frequency of the valid input signal with at least two frequency bands and accordingly passing the valid input signal; and
enabling a voice activated process and an ultrasound activated process simultaneously or separately according to the received valid input signal.
